(19) United States
(12) Patent Application Publication
(10) Pub. No.: US 2026/0142062 A1
(43) Pub. Date: May 21, 2026

(54) METHOD FOR MANUFACTURING FILAMENTS FOR USE IN PIRANI GAUGES AS WELL AS PIRANI GAUGE WITH SUCH A FILAMENT

(71) Applicant: INFICON AG, Balzers (LI)

(72) Inventors: Toai LE QUANG, Azmoos (CH); Hadi TEMORI, Zürich (CH); Gustavo MATA OSORO, Dübendorf (CH); Martin WÜEST, Malans (CH)

(21) Appl. No.: 19/394,485

(22) Filed: Nov. 19, 2025

(30) Foreign Application Priority Data
Nov. 19, 2024 (CH) 001255/2024

(51) Int. Cl. H01C 17/02; G01L 21/12; H01C 1/028

(52) U.S. Cl. CPC H01C 17/02; G01L 21/12; H01C 1/028

(57) ABSTRACT

A method is proposed for manufacturing filaments (1) for Pirani gauges as well as to a Pirani gauge with such a filament (1). The proposed method includes providing filaments (1) with a thin protective coating/layer. The method includes dispersing in a processing chamber (2) a plurality of filaments (1) onto at least one carrier (4) such that they lie freely on the carrier (4) and then applying a thin protective film on the filaments (1) by a thin-film deposition process from a gas phase.

### TECHNICAL FIELD

The present invention relates to a method for manufacturing filaments for use in Pirani gauges as well as to a Pirani gauge with such a filament. The invention in particular pertains to a method for providing filaments with a thin protective coating/layer/film.

### BACKGROUND OF THE INVENTION

Gas pressure measuring devices for use in vacuum systems are often based on the principle of heat conduction / thermal conductivity, i.e., the Pirani principle, and are therefore commonly referred to as Pirani gauges or heat transfer gauges. A Pirani gauge consists of a metal sensor wire or filament (usually tungsten, gold-plated tungsten, nickel or platinum - the first Pirani gauge used tantalum as filament material) suspended in a tube which is connected to the system whose vacuum is to be measured. The sensor wire when heated will lose heat to the surroundings by two main mechanisms, namely thermal radiation and thermal conduction.

While thermal radiation is independent of the gas pressure, thermal conduction is governed by the gas pressure. At lower pressures there are less molecules which collide with the hot filament and remove heat from it. Consequently, the heat loss is slower in vacuum than under normal atmospheric conditions. Measuring the heat loss is therefore an indirect indication of the gas pressure. The electrical resistance of the wire varies with its temperature, so the resistance indicates the temperature of the wire. It is preferable to use sensor wires with a high temperature coefficient of resistance, since then changes in temperature or heat transfer from the wire are better detectable due to more pronounced changes in resistance from which the pressure is determined. In many systems, the wire is maintained at a constant resistance by controlling the current through the wire. The resistance can be set using a bridge circuit, such as a Wheatstone bridge. The current required to keep the resistance constant is then a measure of the vacuum/pressure.

A heating/Pirani element/wire can be used together with a sensor element located in close proximity to the heating element. The heating element is for instance suspended in a tube (in the vacuum) and the sensor element is for instance mounted at a wall of the tube (closed to vacuum like a "lamp"). Both comprise a filament, preferably with the same characteristics. The sensor element is used to measure the temperature which is then employed for temperature compensation.

The use of such a sensor wire in aggressive gases or vapours may lead to a change in the properties of the wire. Often the wire itself is attacked/corroded, making it thinner and changing its resistance. This changes the characteristic of the Pirani gauge which then results in incorrect pressure values. When used in vapours, substances can be deposited on the wire or the wire can be etched and thus degraded. With conductive deposits, the resistance of the wire may change. The temperature coefficient is then dependent on the wire and on the deposits. At the same time, the heat transfer to the surrounding gas will change. Both can shift and change the characteristics again leading to false readings of the gas pressure.

The surface of the wire/filament needs to be protected against oxidation and other corrosion processes. This is especially the case for tungsten filaments. The protection is to ensure a stable performance for a long duration and thus increase the lifetime/service-time of the filament. One way of achieving this is to gold-plate tungsten filaments.

Traditionally, tungsten filaments are annealed in an oxygen containing environment, like in air, to form a thin oxide layer in order to stabilise their surfaces and avoid further changes in the future. Such an annealing process can be carried out in various types of ovens, such as muffle ovens. The formation of oxide depends on the temperature and the duration of the annealing process, which can be controlled either manually or automatically. Modern ovens are equipped with precise thermometers and have good environment control with the possibility to flush the ovens with inert gas. Despite these improvements, it is difficult to strictly control the oxidation rate as well as the thickness and composition of the formed oxide film.

Apart from avoiding oxidisation gold-coating/plating has further advantages, such as providing a bright surface. On the one hand, the bright surface emits low thermal radiation, which dominates the power loss in high vacuum, and improves the performance of Pirani gauges. On the other hand, due to the high electrical conductivity of gold, tungsten filaments have a lower resistance when coated/plated with gold. The thicker the gold layer is, the lower the electrical resistance becomes. As a result, it can be challenging to replace a broken sensor with a new one without any further adjustment for its electronic parts. Contrarily, the electrical resistance of protected tungsten filaments remains unchanged and does not depend on the thickness of the protective material, which is electrically insulating, such as glass, ceramic, paints or plastics (as provided in WO2009059654A1 "Heat conducting gas pressure measurement arrangement"). To produce such filaments, various production techniques, such as melting into glass or being immersed in paint, casting into thermoplastic material or sintering techniques have been proposed. Ideally, filaments should be coated right after their production in order to protect them against oxidation. However, the protective layer will need to be removed partly at places, which need to form a good electrical and thermal contact with other parts of the Pirani gauge. As a result, this adds more steps to the manufacturing/production process and increases the production cost.

There is a need for filaments with improved characteristics, in particular with increased longevity and improved corrosion resistance. Moreover, there is a need for improved or alternative methods for producing such filaments.

### SUMMARY OF THE INVENTION

An object of the present invention is to provide filaments, in particular for use in Pirani gauges, which have a stable performance for a long duration, i.e., attain a long-lasting reproducibility. A further object of the present invention is to provide filaments with improved corrosion resistance which can be employed in aggressive environments. In particular, it is an object of the present invention to provide a method for manufacturing such filaments, especially in an economical manner.

The latter object is achieved by the method for manufacturing filaments as specified in the exemplary aspects.

The former objects are achieved by filaments according to an exemplary aspect, i.e., which are produced according to the method proposed by the present invention.

Pirani gauges with superior characteristics are achieved by employing the filaments according to the present invention and are given in the exemplary aspects.

A method for manufacturing filaments according to the present invention, for use in Pirani gauges, comprises the following steps:

dispersing in a processing(/vacuum/deposition) chamber a plurality of filaments, for instance made of tungsten/ wolfram (or platinum or nickel) onto at least one carrier, such as a Petri disc/dish, such that the filaments lie freely on the carrier, wherein the at least one carrier can be heated;

applying a thin protective film/coating on the filaments by means of a thin-film deposition process from a gas phase, in particular by means of an atomic layer deposition (ALD) or a chemical vapor deposition (CVD) process.

The filaments can be of any shape and have any form, in particular are straight or coiled/helical or double coiled.

Besides traditional coating techniques, dielectric materials can be precisely deposited in a controlled manner from the gas phase using a thin-film deposition process, for instance atomic layer deposition (in short ALD) or chemical vapor deposition (in short CVD). The essential difference between ALD and CVD is that the layer growth in ALD takes place cyclically by means of self-saturating surface reactions. Thereby essentially one atomic layer after the other is generated and the layer is gradually built up. This property is attained through the suitable selection of the process conditions, in particular of the reactants. The advantage of these thin-film deposition processes is the ability to control strictly the thickness of the coating in the nanometre range, allowing to coat a very thin layer of oxide, for instance right after forming the filaments. Due to the extremely low thickness, the layer can be penetrated/destroyed locally by mechanical forces or by a chemical process at the contact points to form a good electrical/thermal contact. Moreover, the emissivity can be reduced by the thin coating thus improving the performance of Pirani gauges. For Pirani gauges, at high vacuum, the main heat loss is due to thermal radiation, which is governed by the emissivity of the filament surface.

The coating of bare filaments is a significant advantage compared to coating assembled sensors in terms of cost-saving. The dimensions of the filaments are very small compared to an assembled sensor and it is possible to perform coating on thousands of filaments per batch simultaneously.

In an embodiment of the method before applying a thin protective film the following step is performed:

applying an ozone plasma to the filaments, in particular at a temperature in a range from 80°C to 200°C, preferably at 100°C, in particular for a duration in the range from 5 to 10 minutes.

In a further embodiment of the method applying a thin protective film comprises:

a) introducing a first precursor into the processing chamber, e.g., Trimethyl-aluminium TMA, in particular in a pulsed manner with a pulse time/duration in a range from 0.1 to 0.5 seconds, more particularly of 0.2 seconds;

b) purging the processing chamber with a further purging gas, in particular an inert gas, such as N₂, in particular for a duration in the range from 2 to 5 seconds, in particular with a flow rate of in the range from 100 to 200 sccm, preferably of 150 sccm;

c) introducing a second precursor into the processing chamber, e.g., H₂O, in particular in a pulsed manner with a pulse time/duration in a range from 0.1 to 0.5 seconds, more particularly of 0.2 seconds;

d) purging the processing chamber with a purging gas, in particular an inert gas, such as N₂, for a longer duration than in step b), in particular for a duration in the range from 4 to 6 seconds, with a higher flow rate than in step b), in particular with a flow rate in the range from 150 to 300 sccm, preferably of 200 sccm;

wherein the steps a) to d) form a single cycle of an atomic layer deposition (ALD) process, which is repeated several times, for instance in a range from 30 to 100 times. The steps a) to d) are all performed at the same temperature in a range from 80°C to 200°C, preferably at 100°C.

ALD is a thin-film deposition technique that allows for atomic-level thickness control through self-limiting reactions. The process alternates between pulses of a precursor and a reactant. In the first step, a precursor - often a metal organic compound or halide - reacts with the available surface sites until all reactive sites are saturated, stopping further growth and forming a monolayer. The self-limiting behaviour ensures precise control. After the excess precursor and byproducts are purged, a reactant, such as H₂O or NH₃, is introduced. The reactant only interacts with the newly formed surface layer, again in a self-limiting manner, creating the final film (e.g., metal oxide, metal nitride). Repeating this cycle allows for the controlled deposition of ultra-thin films with exact thickness and uniformity. The purity of the resulting films is ensured by the high-quality precursors and the carefully controlled reaction environment, minimising impurities and defects like pinholes.

The use of ALD thin-film deposition to coat protective layers on tungsten filaments allows to widen their range of applications as pressure sensing elements to more corrosive environments, where previously only platinum and nickel filaments could be used.

In a further embodiment of the method the steps of applying an ozone plasma and of applying a thin protective film are all performed at essentially the same (low) temperature, in particular at a temperature in a range from 80°C to 200°C, preferably at 100°C.

In a further embodiment of the method a layer of insulating material, in particular ceramic, more particularly one of Al₂O₃, SiO₂, AIN, Y₂O₃ and SiC, or of a metallic material, in particular indium tin oxide (ITO), is formed on the filaments.

Besides insulating materials, an indium tin oxide (ITO) layer can be deposited. This can be a cheaper substitute for gold. This solution also makes it easier to form a good electrical contact between filaments and supporting parts.

In a further embodiment of the method an average growth rate of the layer is in a range from 0.06 nm to 0.1 nm, preferably 0.08 nm, per ALD cycle.

In a further embodiment the method further comprises determining a thickness of the layer deposited on the filaments by measuring a thickness of a layer deposited on a reference substrate, such as a Si substrate or a quartz substrate, in particular using a quartz crystal microbalance (QCM), exposed to the same deposition process as the filaments.

In a further embodiment of the method a final thickness of the layer deposited on the filaments is in a range from 3 nm to 10 nm, in particular 5 nm.

In a further embodiment the method further comprises after dispersing the filaments in the processing chamber and closing the processing chamber, evacuating the processing chamber to a pressure of less than 10⁻¹ mbar using a vacuum pump (along with a vacuum valve and a vacuum measuring cell).

In a further embodiment the method further comprises shaking, rattling or vibrating the at least one carrier and therewith the filaments, in particular during the ALD or CVD process, more particularly after a number of ALD cycles, further in particular periodically during the ALD or CVD process. This is to ensure that the contact areas/ points of the filaments with the carrier that were previously not coated are subsequently exposed to coating. In this way coating all over the filaments is guaranteed. Otherwise, coating holes may remain on the filaments, which are attack points, e.g. for etching gases, and therefore detrimental for the filaments and thus should be avoided.

Alternatively, in a further embodiment of the method, instead of shaking, rattling or vibrating the at least one carrier in order to move about the filaments, pulsating gas flows (e.g., vibrantly increasing the gas flows intermittently when they are on), such as a flow of at least one of the first precursor, the purging gas and the second/further precursor can be employed to agitate the filaments directly. Movement of the filaments can in particular be achieved by jetting or spurting or "puffing" the (purging) gas, e.g., at the beginning or end of purging the processing chamber, or intermittently during purging.

According to a further aspect of the present invention a filament for use in Pirani gauges is proposed manufactured according to the method presented above using any combination of the stated embodiments.

According to another aspect of the present invention a Pirani gauge is proposed with a filament as mentioned above, wherein the filament acts as a heating element and/or measuring/sensor element.

### BRIEF DESCRIPTION OF THE DRAWING

In the following the invention will be described by example with reference to the attached figure, which depicts:

FIG. 1 schematically a processing arrangement for carrying out the thin-film coating method according to the invention.

### DETAILED DESCRIPTION OF THE INVENTION

Coating of a protective layer on a plurality of filaments 1 is for instance made possible according to the invention through an ALD thin-film deposition process from a gas phase as described in the following using a preferred example of a deposition of a preferred protective layer of Al₂O₃.

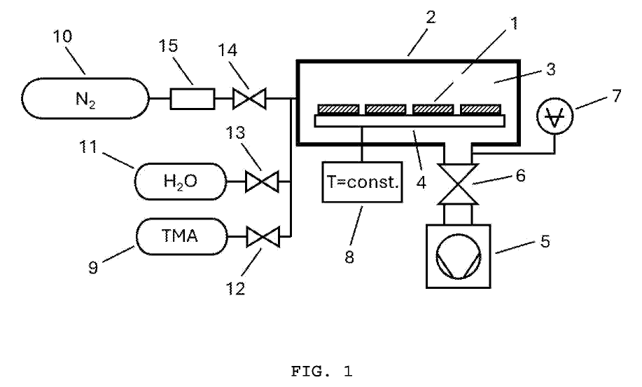

As illustrated in FIG. 1, filaments 1 are introduced into a processing chamber 2 enclosing a processing space 3. The chamber 2 includes a carrier 4. The walls of the chamber 2 and/or the carrier 4 can be heated by a heating mechanism. A temperature regulator 8 including a temperature sensor controls the temperature within the chamber 2, in particular at the carrier 4. The filaments 1 are placed onto the carrier 4 such that they lie freely on the carrier 4. The carrier 4 can be adapted to shake, rattle or vibrate (from time to time) such that the filaments 1 are moved/agitated during the coating process to ensure that the contact areas/points of the filaments 1 with the carrier 4 that were previous not coated are subsequently exposed to coating. This enhances the uniformity of the coating and ensures that the coating covers the filaments 1 all over in their entirety.

After the chamber 2 has been closed and sealed, it is evacuated by means of a vacuum pump 5 to a final pressure of less than 10⁻¹ mbar. As is conventional, apart from the vacuum pump 5, the pump arrangement comprises a vacuum valve 6 and a vacuum measuring cell 7 for monitoring the vacuum conditions. During this time the heating mechanism heats up the whole chamber 2 including the carrier 4 with the filaments 1. For coating with Al₂O₃ the filaments 1 are heated to a temperature of 100°C which is set with the help of the temperature regulator 8. An ozone plasma is then applied to the filaments 1 at a temperature of 100°C for a duration of about 5 to 10 minutes. The goal of this short cleaning step is to remove any potential residues on the surface of the filaments 1 and to enhance the adhesion of the oxide layer without creating any oxide layer. Once the plasma cleaning is completed, the deposition process follows in cycles. One coating/deposition cycle is defined by the following four process steps:

1) Introduction of a first precursor, such as TMA, with a pulse time of 0.1 to 0.5 seconds;

2) Purging of the chamber 2 with a purge gas, such as N₂, for a duration of 2 to 5 seconds;

3) Introduction of a second precursor, such as H₂O, with a pulse time of 0.1 to 0.5 seconds;

4) Purging of the chamber 2 with the purge gas (N₂) for a duration of 4 to 6 seconds.

Both precursors are vaporised at ambient temperature from the precursor sources 9 and 11, since the vapor pressures in the processing space 3 are sufficiently large for fast coverage of the surfaces of the filaments 1. The precursors are introduced into the chamber 2 in a pulsed manner into. For this purpose, the pulse valves 12 and 13 are opened for a period of 0.1 to 0.5 seconds. The purge gas, for example nitrogen, is provided from a purge gas source 10 via a purge gas valve 14. By varying the purge gas flow by means of a flow regulator 15 during the coating cycles a process pressure of approximately 1 mbar is set in order to ensure sufficient flow of the precursors over the filaments, on the one hand, and good purging between the process steps, on the other hand. A vacuum measuring cell 7 is employed for monitoring and regulating the process pressure.

All the steps 1 to 4 stated above are performed at essentially the same temperature as the previous cleaning step, so that only a Al₂O₃ layer is formed on the filaments 1. A low temperature condition is used, so that no tungsten oxide but only a thin Al₂O₃ film is formed. The average growth rate is about 0.08 nm per cycle. To achieve a preferred thickness of the protective coating of 5 nm on the order of 60 ALD cycles are required.

The first and the second/further precursor as well as the purge gas are sequentially introduced into the chamber 2 via the valves 12, 13 and 14 operated under control and pulsed according to predetermined intervals and the purge gas is preferably introduced via a gas flow regulator 15. The process can be fully automated using a process controller and even long processes with a large number of cycles can thereby be carried out very economically. In addition to the use of only two precursors, several precursors can also be utilised when required and even a profile with variation of different material compositions can also be attained. The thickness of the layer deposited on the filaments 1 can be monitored by measuring a thickness of a layer deposited on a reference substrate (not shown), such as a Si substrate or a quartz substrate, for instance using a quartz crystal microbalance (QCM, not shown) exposed to the same deposition process as the filaments 1. The achieved layer quality can be checked by installing the thus produced filaments in Pirani gauges. These Pirani gauges are then used for an extended period of time during which any drift of their readings is monitored. Chemical etching tests can also be employed to evaluate the quality of the protective layers.

Preferred first precursors are for instance trimethyl-aluminium (TMA) for creating an Al₂O₃ coating, titanium chlorides or titanium tert-butoxides for creating a TiO₂ coating, and tantalum ethoxides for creating a Ta₂O₅ coating. The second precursor is an oxidising agent, preferably water (H₂O). As the purge gas an inert gas is utilised, such as a rare gas, for example argon or preferably nitrogen.

In summary, with the proposed ALD coating process the following advantages can be achieved:

uniform distribution of the layer thickness for the protective layer;

high density of the layer material and consequently high impermeability;

good quality of the interface between filament and coating, i.e., good adhesion;

low process temperatures can be used, in particular for Al₂O3 protective coatings; and

the resulting protective coating leads to an extension of the service life of filaments, compared to uncoated filaments, by a factor of 10 or more.

### LIST OF REFERENCE SYMBOLS

1 filament

2 vacuum/processing/deposition chamber

3 processing space

4 carrier

5 vacuum pump

6 vacuum valve

7 vacuum measuring cell/device

8 temperature regulator

9 first precursor source

10 purge gas source

11 second/further precursor source

12 first precursor valve

13 second/further precursor valve

14 purge gas valve

15 purge gas flow regulator

1. A method for manufacturing filaments (1) for Pirani gauges, comprising the steps of:
dispersing in a processing chamber (2) a plurality of filaments (1) onto at least one carrier (4) such that the filaments (1) lie freely on the carrier (4), wherein the at least one carrier (4) is configured to be heated;
applying a thin protective film on the filaments (1) by a thin-film deposition process from a gas phase.

2. The method according to claim 1, wherein before applying a thin protective film performing the step of:
applying an ozone plasma to the filaments (1).

3. The method according to claim 1, wherein applying the thin protective film comprises:
a) introducing a first precursor into the processing chamber (2);
b) purging the processing chamber (2) with a purging gas;
c) introducing a second precursor into the processing chamber (2);
d) purging the processing chamber (2) with a further purging gas for a longer duration than in step b) with a higher flow rate than in step b);
wherein the steps a) to d) form a single cycle of an atomic layer deposition (ALD) process, which is repeated several times, for instance in a range from 30 to 100 times.

4. The method according to claim 1, wherein the steps of applying an ozone plasma and of applying a thin protective film are all performed at essentially a same temperature.

5. The method according to claim 1, wherein a layer of insulating material is formed on the filaments.

6. The method according to claim 3, wherein an average growth rate of the layer is in a range from 0.06 nm to 0.1 nm per ALD cycle.

7. The method according to claim 1, further comprising determining a thickness of the layer deposited on the filaments (1) by measuring a thickness of a layer deposited on a reference substrate.

8. The method according to claim 3, wherein a final thickness of the layer deposited on the filaments is in a range from 3 nm to 10 nm.

9. The method of claim 3, further comprising after dispersing the filaments (1) in the processing chamber (2) and closing the processing chamber (2), evacuating the processing chamber (2) to a pressure of less than 10⁻¹ mbar.

10. The method of claim 1, further comprising shaking, rattling or vibrating the at least one carrier (4) and therewith the filaments (1).

11. The method of claim 1, further comprising agitating the filaments (1) by pulsating a gas flow.

12. A filament (1) for use in Pirani gauges manufactured according to the method of claim 1.

13. A Pirani gauge with a filament (1) according to claim 12, wherein the filament (1) acts as a heating element or a measuring element.
